(19) United States
(12) Patent Application Publication
(10) Pub. No.: US 2023/0203293 A1
(43) Pub. Date: Jun. 29, 2023

(54) LOW-DENSITY ABS COMPOSITES

(71) Applicant: INEOS STYROLUTION GROUP GMBH, Frankfurt am Main (DE)

(72) Inventors: Norbert NIESSNER, Friedelsheim (DE); Shridhar MADHAV, Vadodara (IN); Kirit GEVARIA, Vadodara (IN); Manjula AK, Vadodara, Gujarat (IN); Pratik BHAVSAR, Gujarat (IN)

(21) Appl. No.: 17/999,663

(22) PCT Filed: May 25, 2021
(86) PCT No.: PCT/EP2021/063853

§ 371 Date: Nov. 22, 2022

(30) Foreign Application Priority Data
May 29, 2020 (EP) 20177372.8

(51) Int. Cl. C08L 25/12; C08K 13/04; C08J 3/20

(52) U.S. Cl. CPC C08L 25/12; C08K 13/04; C08J 3/201; C08L 2205/03; C08L 2205/025; C08L 2203/30; C08L 2205/08; C08K 2201/005; C08K 7/28

(57) ABSTRACT

The invention relates to a thermoplastic molding composition comprising 5.0 to 57 wt.-% ABS graft copolymer (A); 30.5 to 80 wt.-% SAN copolymer (B) 1.5 to 9.5 wt.-% copolymer (C) with epoxy, maleic anhydride or maleic imide functions; 5 to 29 wt.-% of hollow glass microspheres (D); 6 to 12 wt.-% of glass fibers (E); 0 to 5 wt.-% additives and/or processing aids (F), having a low density and high strength, and a process for its preparation, shaped arti-cles thereof, and its use in the electronics sector.

The invention relates to reinforced ABS (acrylonitrile-butadiene-styrene) molding compositions having a low density and high strength, a process for their preparation, shaped articles comprising said molding composition, and the use of the molding composition in particular in the electronics sector.

Current industrial practice is to reinforce ABS resins by glass fibers, mineral fillers or in some cases with carbon fibers. This provides good enhancements of mechanical properties of ABS resins but the density of the ABS composition is considerably increased. Parts or articles made from these compositions are mainly used in the electronics and household sector. Said sectors try to reduce the consumption of electricity as much as possible and thereby save much energy, finally directing to decreased emissions which is advantageous today. Highly dense glass fiber filled compositions are rather unsuccessful in achieving the above stated purpose.

WO 2019/086431 concerns fibre-reinforced composite materials comprising fibre material comprising a plurality of continuous fibres, each formed from filaments, a matrix material made of plastic, and glass particles, in particular hollow glass bodies. Polypropylene, polyether ketone and/or polycarbonate are preferably used as the matrix material; the filaments are typically glass fibres, carbon fibres, polymer fibres and/or natural fibres; and the fibre material is preferably a glass fibre woven or non-woven fabric.

CN-A 103849143 relates to a lightweight glass fiber reinforced polyamide material comprising 100 pbw of nylon 66, 20-80 pbw of glass fibers, 5-20 pbw of hollow glass beads and 5-18 pbw of compatibilizer (i.e. a maleic anhydride/olefin graft copolymer).

EP-A 3184586 describes a light weight fiber reinforced polypropylene composition for automotive articles comprising 10 to 85 wt % of a polypropylene, 12.5 to 53 wt % of fibers, preferably glass fibers, 2 to 12 wt % of hollow glass beads, and 0.5 to 5 wt.-% of a polar modified polypropylene (PMP) as coupling agent.

US 2013/0116353 discloses a porous light weight resin composition for automobile parts which comprises: (A) 70-80 wt.-% of a polypropylene resin, polyamide 6, or a blend of both with a compatibilizer (i.e. maleinized polypropylene); (B) 4-10 wt.-% of an inorganic filler; (C) 4-10 wt.-% of an inorganic reinforcing material (e.g. short glass fibers); (D) 4-10 wt.-% of a hollow glass microsphere; (E) 4-10 wt.-% of a porous microparticle; and (F) 1-5 wt.-% of a blowing agent.

CN-A 102746606 discloses a modified acrylonitrile-butadiene-styrene (ABS) material for instruments and household-applications filled with hollow glass microbeads comprising: 50 to 80 wt.-% of ABS resin (no details about composition), 3 to 5 wt.-% of a compatibilizer, 5 to 10 wt.-% of a toughener (e.g. hydrogenated SBS styrene-based thermoplastic elastomer), 3 to 5 wt.-% of a silane coupling agent, 1 to 3 wt.-% of a reinforcing agent (ultrafine silica) , 5 to 30 wt.-% of hollow glass beads (i.e. soda lime borosilicate), and 1 to 3 wt.-% of plastic processing assistants. As compatibilizer a styrene maleic anhydride graft copolymer (S-g-MAH) is used.

The use of fibers and light weight applications are not mentioned.

WO 2015162242 discloses a foamed light weight styrene polymer composition for automotive applications comprising: A) 40 to 88% by weight of an ABS and/or ASA resin, B) 5 to 30% by weight of hollow glass microspheres (i.e. soda lime borosilicate, particle size (diameter) 5 to 50 μm), C) 0.1 to 2.5% by weight of a chemical foaming agent, D) 1 to 5% by weight of a compatibilizing agent (e.g. a styrene-acrylonitrile grafted maleic anhydride copolymer), E) 5 to 20% by weight of an impact modifier, and F) optionally 0.1 to 3% by weight of a plastic processing aid. Preferably the ABS resin is a mixture of graft copolymer A1)—a diene based rubber onto which a copolymer of styrene and acrylonitrile is grafted—with 40 to 85 wt.-% of a rubber free styrene-acrylonitrile (SAN) copolymer A2) (AN content preferably 22 to 30 wt.-%). Compositions with glass fibers are not disclosed. The use in the electronics sector, in particular for applications which necessitate high fatigue resistance and endurance, is not mentioned.

CN-A 103421270 relates to a low thermal expansion-coefficient conductive ABS material for use in electronic parts which comprises 40 to 88 pbw of an ABS resin (no details about composition), 10 to 25 pbw of hollow glass beads, 5 to 25 pbw of a carbon fiber, 5 to 15 parts by weight of a compatibilizer, 0.2 to 0.7 parts by weight of a lubricant and 0.2 to 0.5 parts by weight of an antioxidant. As compatibilizer an ABS-g-MAH graft copolymer or a styrene-maleic anhydride copolymer (SMAH) is used. Glass fibers and the use for applications which necessitate light weight, high fatigue resistance and endurance are not mentioned.

The afore-mentioned prior art compositions are still in need of improvement in respect to cost of production and balance in mechanical properties and reduction of part weight.

It is one object of the invention to provide thermoplastic molding compositions which do not have the afore-mentioned disadvantages. Thus, cost-effective lightweight thermoplastic molding compositions shall be provided having a low density (specific gravity) combined with sufficient mechanical strength. It was surprisingly found that the problem can be solved by the thermoplastic molding composition according to the claims.

One aspect of the invention is a thermoplastic molding composition comprising (or consisting of) components A, B, C, D, E and, if present, F:

(A) 5.0 to 57.0 wt.-% of at least one graft copolymer (A) consisting of 15 to 60 wt.-%, preferably 20 to 50 wt.-% of a graft sheath (A2) and 40 to 85 wt.-%, preferably 50 to 80 wt.-% of a graft substrate—an agglomerated butadiene rubber latex—(A1), where (A1) and (A2) sum up to 100 wt.-%,
obtained by emulsion polymerization of
styrene and acrylonitrile in a weight ratio of 95:5 to 50:50 to obtain a graft sheath (A2), it being possible for styrene and/or acrylonitrile to be replaced partially (less than 50 wt.-%) by alpha-methylstyrene, methyl methacrylate or maleic anhydride or mixtures thereof,
in the presence of at least one agglomerated butadiene rubber latex (A1) with a median weight particle diameter D₅₀ of 200 to 800 nm, preferably 225 to 650 nm, more preferably 250 to 600 nm, most preferred 280 to 350 nm; where the agglomerated rubber latex (A1) is obtained by agglomeration of at least one starting butadiene rubber latex (S-A1) having a median weight particle diameter D₅₀ of equal to or less than 120 nm, preferably equal to or less than 110 nm;

(B) 30.5 to 80 wt.-%, preferably 35 to 80 wt.-%, more preferably 40 to 70 wt.-%, most preferably 42 to 60 wt.-%, in particular 43 to 55 wt.-%, of at least one copolymer (B) of styrene and acrylonitrile in a weight ratio of from 81:19 to 65:35, preferably 77:23 to 68:32, more preferably 76:24 to 70:30, it being possible for styrene and/or acrylonitrile to be partially (less than 50 wt.-%) replaced by methyl methacrylate, alpha-methyl styrene and/or 4-phenylstyrene, preferably alpha-methyl styrene; wherein copolymer (B) has a weight average molar mass M_{w} of 90,000 to 145,000 g/mol, preferably 95,000 to 130,000 g/mol, more preferably 100,000 to 115,000 g/mol;

(C) 1.5 to 9.5 wt.-%, preferably 2 to 8 wt.-%, more preferably 3 to 6 wt.-%, in particular 4 to 5.5 wt.-%, of at least one copolymer (C)—as compatibilizing agent—with at least one functional group selected from epoxy, maleic anhydride and maleic imide;

(D) 5 to 29 wt.-%, preferably 5 to 25 wt.-%, more preferably 8 to 22 wt.-%, most preferably 9 to 20 wt.-%, of hollow glass microspheres (D);

(E) 6 to 12 wt.-%, preferably 7 to 11.5 wt.-%, more preferably 8 to 11 wt.-%, most preferably 9 to 10.5 wt.-% of glass fibers (E);

(F) 0 to 5 wt.-% of further additives and/or processing aids (F)—different from (D) and (E); where the components A, B, C, D, E and, if present F, sum to 100 wt.-%.

If component (F) is present, its minimum amount is 0.01 wt.-%, based on the entire thermoplastic molding composition molding compound. Wt.-% means percent by weight.

The median weight particle diameter D₅₀, also known as the D₅₀ value of the integral mass distribution, is defined as the value at which 50 wt.-% of the particles have a diameter smaller than the D₅₀ value and 50 wt.-% of the particles have a diameter larger than the D₅₀ value.

In the present application the weight-average particle diameter D_{w}, in particular the median weight particle diameter D₅₀, is determined with a disc centrifuge (e.g.: CPS Instruments Inc. DC 24000 with a disc rotational speed of 24 000 rpm).

The weight-average particle diameter D_{w} is defined by the following formula (see G. Lagaly, O. Schulz and R. Ziemehl, Dispersionen and Emulsionen: Eine Einführung in die Kolloidik feinverteilter Stoffe einschließlich der Tonminerale, Darmstadt: SteinkopfVerlag 1997, ISBN 3-7985 -1087-3, page 282, formula 8.3b):

D_{w}=sum (nᵢ*dᵢ⁴)/sum(nᵢ*d³) nᵢ is number of particles of diameter dᵢ.

The summation is performed from the smallest to largest diameter of the particles size distribution. It should be mentioned that for a particles size distribution of particles with the same density which is the case for the starting rubber latices and agglomerated rubber latices the volume average particle size diameter Dv is equal to the weight average particle size diameter Dw.

The weight average molar mass M_{w} is determined by GPC (solvent: tetrahydrofuran, polystyrene as polymer standard) with UV detection according to DIN 55672-1:201603.

It is preferable that the thermoplastic molding composition of the invention comprises (or consists of):

5.99 to 50.99 wt.-% component (A),

35 to 80 wt.-% component (B),

2 to 8 wt.-% component (C),

5 to 25 wt.-% component (D),

7 to 11.5 wt -% component (E),

0.01 to 5 wt.-% component (F).

It is particularly preferable that the molding composition comprises (or consists of):

11.95 to 41.95 wt.-% component (A),

40 to 70 wt.-% component (B),

3 to 6 wt.-% component (C),

8 to 22 wt.-% component (D),

7 to 11.5 wt.-% component (E),

0.05 to 4 wt.-% component (F).

It is most preferable that the molding composition comprises (or consists of):

18.90 to 36.9 wt.-% component (A),

42 to 60 wt.-% component (B),

4 to 6 wt.-% component (C),

9 to 20 wt.-% component (D),

8 to 11 wt.-% component (E),

0.10 to 3 wt.-% component (F).

### Component (A)

Graft copolymer (A) (component (A)) is known and described in WO 2012/022710. Graft copolymer (A) consists of 15 to 60 wt.-% of a graft sheath (A2) and 40 to 85 wt.-% of a graft substrate—an agglomerated butadiene rubber latex—(A1), where (A1) and (A2) sum up to 100 wt.-%.

Preferably graft copolymer (A) is obtained by emulsion polymerization of styrene and acrylonitrile in a weight ratio of 80:20 to 65:35 to obtain a graft sheath (A2), it being possible for styrene and/or acrylonitrile to be replaced partially (less than 50 wt.-%, preferably less than 20 wt.-%, more preferably less than 10 wt.-%, based on the total amount of monomers used for the preparation of (A2)) by alpha-methylstyrene, methyl methacrylate or maleic anhydride or mixtures thereof, in the presence of at least one agglomerated butadiene rubber latex (A1) with a median weight particle diameter D₅₀ of 200 to 800 nm, preferably 225 to 650 nm, more preferably 250 to 600 nm, most preferred 280 to 350 nm, in particular 300 to 350 mm.

Preferably the at least one, preferably one, graft copolymer (A) consists of 20 to 50 wt.-% of a graft sheath (A2) and 50 to 80 wt.-% of a graft substrate (A1). More preferably graft copolymer (A) consists of 30 to 45 wt.-% of a graft sheath (A2) and 55 to 70 wt.-% of a graft substrate (A1).

Preferably graft copolymer (A) consists of 35 to 45 wt.-% of a graft sheath (A2) and 55 to 65 wt.-% of a graft substrate (A1).

Preferably the obtained graft copolymer (A) has a core-shell-structure; the graft substrate (a1) forms the core and the graft sheath (A2) forms the shell.

Preferably for the preparation of the graft sheath (A2) styrene and acrylonitrile are not partially replaced by one of the above-mentioned comonomers; preferably styrene and acrylonitrile are polymerized alone in a weight ratio of 95:5 to 50:50, preferably 80:20 to 65:35.

The at least one, preferably one, starting butadiene rubber latex (S-A1) preferably has a median weight particle diameter D₅₀ of equal to or less than 110 nm, particularly equal to or less than 87 nm.

The term “butadiene rubber latex” means polybutadiene latices produced by emulsion polymerization of butadiene and less than 50 wt.-% (based on the total amount of monomers used for the production of polybutadiene polymers) of one or more monomers that are copolymerizable with butadiene as comonomers.

Examples for such monomers include isoprene, chloroprene, acrylonitrile, styrene, alpha-methylstyrene, C₁-C₄-alkylstyrenes, C₁-C₈-alkylacrylates, C₁-C₈-alkylmethacrylates, alkyleneglycol diacrylates, alkylenglycol dimethacrylates, divinylbenzol; preferably, butadiene is used alone or mixed with up to 30 wt.-%, preferably up to 20 wt.-%, more preferably up to 15 wt.-% styrene and/or acrylonitrile, preferably styrene.

Preferably the starting butadiene rubber latex (S-A1) consists of 70 to 99 wt.-% of butadiene and 1 to 30 wt.-% styrene.

More preferably the starting butadiene rubber latex (S-A1) consists of 85 to 99 wt.-% of butadiene and 1 to 15 wt.-% styrene.

Most preferably the starting butadiene rubber latex (S-A1) consists of 85 to 95 wt.-% of butadiene and 5 to 15 wt.-% styrene.

The agglomerated rubber latex (graft substrate) (A1) is obtained by agglomeration of the above-mentioned starting butadiene rubber latex (S-A1) with preferably at least one acid anhydride, more preferably acetic anhydride or mixtures of acetic anhydride with acetic acid, in particular acetic anhydride.

The preparation of graft copolymer (A) is described in detail in WO 2012/022710. It can be prepared by a process comprising the steps: α) synthesis of starting butadiene rubber latex (S-A1) by emulsion polymerization, β) agglomeration of latex (S-A1) to obtain the agglomerated butadiene rubber latex (A1) and γ) grafting of the agglomerated butadiene rubber latex (A1) to form a graft copolymer (A).

The synthesis (step α)) of starting butadiene rubber latices (S-A1) is described in detail on pages 5 to 8 of WO 2012/022710 A1.

Preferably the starting butadiene rubber latices (S-A1) are produced by an emulsion polymerization process using metal salts, in particular persulfates (e.g. potassium persulfate), as an initiator and a rosin-acid based emulsifier.

As resin or rosin acid-based emulsifiers, those are being used in particular for the production of the starting rubber latices by emulsion polymerization that contain alkaline salts of the rosin acids. Salts of the resin acids are also known as rosin soaps. Examples include alkaline soaps as sodium or potassium salts from disproportionated and/or dehydrated and/or hydrated and/or partially hydrated gum rosin with a content of dehydroabietic acid of at least 30 wt.-% and preferably a content of abietic acid of maximally 1 wt.-%. Furthermore, alkaline soaps as sodium or potassium salts of tall resins or tall oils can be used with a content of dehydroabietic acid of preferably at least 30 wt.-%, a content of abietic acid of preferably maximally 1 wt.-% and a fatty acid content of preferably less than 1 wt.-%.

Mixtures of the aforementioned emulsifiers can also be used for the production of the starting rubber latices. The use of alkaline soaps as sodium or potassium salts from disproportionated and/or dehydrated and/or hydrated and/or partially hydrated gum rosin with a content of dehydroabietic acid of at least 30 wt.-% and a content of abietic acid of maximally 1 wt.-% is advantageous.

Preferably the emulsifier is added in such a concentration that the final particle size of the starting butadiene rubber latex (S-A1) achieved is from 60 to 110 nm (median weight particle diameter D₅₀).

Polymerization temperature in the preparation of the starting rubber latices (S-A1) is generally 25° C. to 160° C., preferably 40° C. to 90° C. Further details to the addition of the monomers, the emulsifier and the initiator are described in WO 2012/022710. Molecular weight regulators, salts, acids and bases can be used as described in WO 2012/022710. Then the obtained starting butadiene rubber latex (S-A1) is subjected to agglomeration (step (3)) to obtain an agglomerated rubber latex (A1). The agglomeration may be carried out as described in detail on pages 8 to 12 of WO 2012/022710 A1. Said method is preferred.

Preferably acetic anhydride, more preferably in admixture with water, is used for the agglomeration. Preferably the agglomeration step β) is carried out by the addition of 0.1 to 5 parts by weight of acetic anhydride per 100 parts of the starting rubber latex solids.

The agglomerated rubber latex (A1) is preferably stabilized by addition of further emulsifier while adjusting the pH value of the latex (A1) to a pH value (at 20° C.) between pH 7.5 and pH 11, preferably of at least 8, particular preferably of at least 8.5, in order to minimize the formation of coagulum and to increase the formation of a stable agglomerated rubber latex (A1) with a uniform particle size. As further emulsifier preferably rosin-acid based emulsifiers as described above in step step α) are used. The pH value is adjusted by use of bases such as sodium hydroxide solution or preferably potassium hydroxide solution.

The obtained agglomerated latex rubber latex (A1) has a median weight particle diameter D₅₀ of generally 200 to 800 nm, preferably 225 to 650 nm, more preferably 250 to 600 nm, most preferred 280 to 350 nm, in particular 300 to 350 nm. The obtained agglomerated latex rubber latex (A1) preferably is mono-modal.

In step γ) the agglomerated rubber latex (A1) is grafted to form the graft copolymer (A). Suitable grafting processes are described in detail on pages 12 to 14 of WO 2012/022710.

Graft copolymer (A) is obtained by emulsion polymerization of styrene and acrylonitril—optionally partially replaced by alpha-methylstyrene, methyl methacrylate and/or maleic anhydride—in a weight ratio of 95:5 to 50:50 to obtain a graft sheath (A2) (in particular a graft shell) in the presence of the above-mentioned agglomerated butadiene rubber latex (A1).

Preferably graft copolymer (A) has a core-shell-structure.

The grafting process of the agglomerated rubber latex (A1) of each particle size is preferably carried out individually.

Preferably the graft polymerization is carried out by use of a redox catalyst system, e.g. with cumene hydroperoxide or tert.-butyl hydroperoxide as preferable hydroperoxides. For the other components of the redox catalyst system, any reducing agent and metal component known from literature can be used.

According to a preferred grafting process which is carried out in presence of at least one agglomerated butadiene rubber latex (A1) with a median weight particle diameter D₅₀ of preferably 280 to 350 nm, more preferably 300 to 330 nm, in an initial slug phase 15 to 40 wt.-%, more preferably 26 to 30 wt.-%, of the total monomers to be used for the graft sheath (A2) are added and polymerized, and this is followed by a controlled addition and polymerization of the remaining amount of monomers used for the graft sheath (A2) till they are consumed in the reaction to increase the graft ratio and improve the conversion. This leads to a low volatile monomer content of graft copolymer (A) with better impact transfer capacity.

Further details to polymerization conditions, emulsifiers, initiators, molecular weight regulators used in grafting step y) are described in WO 2012/022710.

### Component (B)

In the thermoplastic molding composition according to the invention copolymer (B) (=matrix polymer) is generally comprised in an amount of 30.5 to 80 wt.-%, preferably 35 to 80 wt.-%, more preferably 40 to 70 wt.-%, most preferably 42 to 60 wt.-%, particularly most preferred 43 to 55 wt.-%.

Preferably copolymer (B) (=component (B)) is a copolymer of styrene and acrylonitrile in a weight ratio of from 77:23 to 68:32, more preferably 76:24 to 70:30, most preferably 74:26 to 72:28, it being possible for styrene and/or acrylonitrile to be partially (less than 50 wt.-%, preferably less than 20 wt.-%, more preferably less than 10 wt.-%, based on the total amount of monomers used for the preparation of (B)) replaced by alpha-methyl styrene and/or 4-phenylstyrene, preferably alpha-methyl styrene.

It is preferred that styrene and acrylonitrile are not partially replaced by one of the above-mentioned comonomers. Component (B) is preferably a copolymer of styrene and acrylonitrile.

Copolymer (B) has preferably a melt flow index (MFI) of 60 to 70 g/10 min (ASTM D1238).

The weight average molar mass M_{w} of copolymer (B) generally is 90,000 to 145,000 g/mol, preferably 95,000 to 130,000 g/mol, more preferably 100,000 to 115,000 g/mol.

Details relating to the preparation of such copolymers are described, for example, in DE-A 2 420 358, DE-A 2 724 360 and in Kunststoff-Handbuch ([Plastics Handbook], Vieweg-Daumiller, volume V, (Polystyrol [Polystyrene]), Carl-Hanser-Verlag, Munich, 1969, pp. 122 ff., lines 12 ff.). Such copolymers prepared by mass (bulk) or solution polymerization in, for example, toluene or ethylbenzene, have proved to be particularly suitable.

### Component (C)

In the thermoplastic molding composition according to the invention copolymer (C) is generally comprised in an amount of 1.5 to 9.5 wt.-%, preferably 2 to 8 wt.-%, more preferably 3 to 6 wt.-%, most preferably 4 to 6 wt.-%, particularly most preferred 4 to 5.5 wt.-%. Preferably copolymer (C) comprises structural units derived from maleic imide, in particular N-phenyl maleic imide, and/or maleic anhydride.

Copolymers (C) often comprise structural units derived from maleic imide and/or maleic anhydride in an amount of from 1 to 30 wt.-%, preferably 6 to 12 wt.-%, more preferably 8 to 10 wt.-%.

Copolymer (C) functions as a compatibilizing agent between the glass reinforcing agents (components D and E) and the matrix polymer by improving the bonding of the hollow glass beads and the glass fibers to the matrix polymer phase.

Preferably in the thermoplastic molding composition according to the invention the compatibilizing agent (C) is comprised in an amount of 2 to 8 wt.-%, more preferably 3 to 6 wt.-%, most preferably 4 to 5.5 wt.-%.

More preferably copolymer (C) is selected from the group consisting of: styrene-maleic anhydride copolymers, styrene-acrylonitrile-maleic anhydride-terpolymers, styrene-N-phenyl maleic imide-copolymers and styrene-acrylonitrile-N-phenyl maleic imideterpolymers.

In particular preferred are styrene-acrylonitrile-maleic anhydride terpolymers.

Most preferred are styrene-acrylonitrile-maleic anhydride terpolymers comprising structural units derived from maleic anhydride in an amount of 6 to 10 wt.-%, in particular 8 wt.-%.

The preparation of copolymer (C) is commonly known. It can be advantageously prepared by mass (bulk) or solution polymerization by a continuous free radical polymerization process.

Copolymer (C) has preferably a melt flow index (MFI) in the range of 90 to 110 g/10 min (ASTM D1238).

The weight average molar mass M_{w} of copolymer (C) is generally in the range of from 80,000 to 145,000 g/mol, preferably in the range of from 90,000 to 100,000 g/mol.

### Component D

In the thermoplastic molding composition according to the invention component (D) (=hollow glass microspheres or hollow glass beads) is generally comprised in an amount of 5 to 29 wt.-%, preferably 5 to 25 wt.-%, more preferably 8 to 22 wt.-%, most preferably 9 to 20 wt.-%.

The hollow glass microspheres or hollow glass beads (HGB) used as component (D) comprise inorganic materials which are typically used for glasses such as e.g. silica, alumina, zirconia, magnesium oxide, sodium silicate, soda lime, borosilicate etc.

Preferably the hollow glass beads comprise soda lime borosilicate, which is commercially available.

The hollow glass beads are preferably mono-modal. Generally the hollow glass beads have a particle size (median weight particle diameter D₅₀) in the range of from 20 to 60 pm, preferably 25 to 45 μm, more preferably 30 to 40 μm.

Furthermore it is preferred that the glass beads are of the thin wall type having preferably a wall thickness of 0.5-1.5 μm.

The hollow glass microspheres preferably have a true density of from 0.58 to 0.62 g/cm³. Their bulk density is preferably from 0.33 to 0.36 g/cm³.

The hollow glass microspheres preferably have a compressive strength in the range of 110 to 150 MPa, in particular 115 to 130 MPa.

### Component E

Glass fibers (E) (=component E) are often used in an amount of 6 to 12 wt.-%, preferably from 7 to 11.5 wt.-%, more preferably 8 to 11 wt.-%, most preferably 8.5 to 10.5 wt.-%, in particular 9 to 10 wt.-%.

Glass fibers (E) are commercially available glass fibers, e. g. the traditional A, E, C or S-Glass fibers. Low (less than 1 wt.-% alkali oxide) or non-alkali containing fibers, in particular E-glass fibers, are preferred. In particular preferred are glass fibers composed of Aluminium borosilicate (E-glass) with less than 1% alkali oxides.

Preferred are chopped glass fibers (E). The typical lengths of the glass fibers (E) are 0.1 to 15 mm, preferably 0.5 to 5 mm, more preferred 2 to 5 mm. Typical diameters of the glass fibers (E) are 10 to 100 μm, preferred 10 to 25 μm, more preferred 10 to 15 μm.

Furthermore preferred are afore-mentioned glass fibers (E) which surface is treated with silane.

### Component (F)

Various additives and/or processing aids (F) (=component (F)) may be added to the thermoplastic molding composition according to the invention in amounts of from 0.01 to 5 wt.-%, preferably 0.05 to 4 wt.-%, more preferably 0.1 to 3 wt.-% as assistants and processing additives.

Suitable additives and/or processing aids (F) include, for example, dyes, pigments, colorants, antistats, antioxidants, stabilizers for improving thermal stability, stabilizers for increasing photostability, stabilizers for enhancing hydrolysis resistance and chemical resistance, anti-thermal decomposition agents, dispersing agents, and in particular external/internal lubricants that are useful for production of molded bodies/articles.

These additives and/or processing aids may be admixed at any stage of the manufacturing operation, but preferably at an early stage in order to profit early on from the stabilizing effects (or other specific effects) of the added substance.

Preferably component (F) is at least one lubricant and/or antioxidant.

Suitable lubricants/glidants and demolding agents include stearic acids, stearyl alcohol, stearic esters, amide waxes (bisstearylamide, in particular ethylenebisstearamide), polyolefin waxes and/or generally higher fatty acids, derivatives thereof and corresponding fatty acid mixtures comprising 12 to 30 carbon atoms.

Examples of suitable antioxidants include sterically hindered monocyclic or polycyclic phenolic antioxidants which may comprise various substitutions and may also be bridged by substituents. These include not only monomeric but also oligomeric compounds, which may be constructed of a plurality of phenolic units.

Hydroquinones and hydroquinone analogs are also suitable, as are substituted compounds, and also antioxidants based on tocopherols and derivatives thereof.

It is also possible to use mixtures of different antioxidants. It is possible in principle to use any compounds which are customary in the trade or suitable for styrene copolymers, for example antioxidants from the Irganox range. In addition to the phenolic antioxidants cited above by way of example, it is also possible to use so-called costabilizers, in particular phosphorus- or sulfur-containing costabilizers. These phosphorus- or sulfur-containing costabilizers are known to those skilled in the art.

For further additives and/or processing aids, see, for example, “Plastics Additives Handbook”, Ed. Gächter and Müller, 4th edition, Hanser Publ., Munich, 1996.

### Preparation of Thermoplastic Molding Composition

Further aspects of the invention are a process for the preparation of the thermoplastic molding composition and the production of shaped articles.

The thermoplastic molding composition of the invention may be produced from the components (A), (B), (C), (D), (E) and, if present, (F) by any known method.

Preferably the components (A), (B), (C), (D) and, if present, (F) are premixed and blended by melt mixing, for example conjoint extrusion, preferably with a twin-screw extruder, kneading or rolling of the components. Component (E) is advantageously added after melt mixing and kneading or rolling of the components, preferably component (E) is added by a side-feeder in a zone of the extruder after the kneading section. The melt mixing is generally done at temperatures in the range of from 160° C. to 300° C., preferably from 180° C. to 280° C., more preferably 215° C. to 250°.

The obtained molding composition can be extruded via a die plate and the obtained preferably water cooled—extruded polymer strands are preferably pelletized.

Shaped articles comprising the molding composition according to the invention can be obtained by known processes for thermoplast processing, in particular preferred is injection molding.

The thermoplastic molding compositions according to the invention are cost efficient lightweight compositions having a reduced specific gravity and good mechanical properties such as tensile and flexural properties.

A further aspect of the invention is the use of the thermoplastic molding composition according to the invention or of shaped articles comprising the molding composition according to the invention for applications in the auto, white goods or—in particular—electronic industry. Preferred is the use of the thermoplastic molding composition according to the invention or of shaped articles comprising the molding composition according to the invention for electronic devices where a high endurance and fatigue resistance is required (e.g. fan blades).

The invention is further illustrated by the examples and claims.

### EXAMPLES

### Test Methods

Particle Size Dw/D50

For measuring the weight average particle size Dw (in particular the median weight particle diameter D50) with the disc centrifuge DC 24000 by CPS Instruments Inc. equipped with a low density disc, an aqueous sugar solution of 17.1 mL with a density gradient of 8 to 20% by wt. of saccharose in the centrifuge disc was used, in order to achieve a stable flotation behavior of the particles. A polybutadiene latex with a narrow distribution and a mean particle size of 405 nm was used for calibration. The measurements were carried out at a rotational speed of the disc of 24,000 r.p.m. by injecting 0.1 mL of a diluted rubber dispersion into an aqueous 24% by wt. saccharose solution. The calculation of the weight average particle size Dw was performed by means of the formula

D_{w}=sum (nᵢ*dᵢ⁴)/sum(nᵢ*dᵢ³)

nᵢ: number of particles of diameter di.

Molar Mass M_{w}: The weight average molar mass M_{w} is determined by GPC (solvent:

tetrahydrofuran, polystyrene as polymer standard) with UV detection according to DIN 55672-1:2016-03.

Melt Flow Index (MFI) or Melt Volume Flow Rate (MFR): MFI/MFR test was performed on pellets (ASTM D 1238) using a MFI-machine of CEAST, Italy.

Impact test: Izod impact tests were performed on notched specimens (ASTM D 256 standard) using an instrument of CEAST (part of Instron's product line), Italy.

Tensile test: Tensile test was carried out at 23° C. using a Universal testing Machine (UTM) of Lloyd Instruments, UK.

Flexural test: Flexural test was carried out at 23° C. (ASTM D 790 standard) using a UTM of Lloyd Instruments, UK.

Heat deflection temperature (HDT): Heat deflection temperature test was performed on injection molded specimen (ASTMD 648 standard) using a CEAST, Italy instrument.

VICAT Softening Temperature (VST): VST test was performed on injection molded test specimen (ASTM D 1525-09 standard) using a Zwick Roell machine, Germany. Test was carried out at a heating rate of 120° C./hr (Method B) at 50 N loads.

Rockwell Hardness: Hardness of the injection molded test specimen (ISO—2039/211) was carried out on FIE, India.

Specific gravity: The measurement was done on a specific gravity (ASTM D 792) balance from Mettler Toledo.

Strength to weight ratio: measured as the ratio of tensile strength to the specific gravity of the material.

Yellowness Index: testing as per ASTM E313 at D65/10

Materials used in the experiments:

### Component (A)

### Fine-Particle Butadiene Rubber Latex (S-A1)

The fine-particle butadiene rubber latex (S-A1) which is used for the agglomeration step was produced by emulsion polymerization using tert-dodecylmercaptan as chain transfer agent and potassium persulfate as initiator at temperatures from 60° to 80° C. The addition of potassium persulfate marked the beginning of the polymerization. Finally the fine-particle butadiene rubber latex (S-A1) was cooled below 50° C. and the non reacted monomers were removed partially under vacuum (200 to 500 mbar) at temperatures below 50° C. which defines the end of the polymerization. Then the latex solids (in % per weight) were determined by evaporation of a sample at 180° C. for 25 min. in a drying cabinet. The monomer conversion is calculated from the measured latex solids.

The butadiene rubber latex (S-A1) is characterized by the following parameters, see table 1.

Latex S-A1-1

No seed latex is used. As emulsifier the potassium salt of a disproportionated rosin (amount of potassium dehydroabietate: 52 wt.-%, potassium abietate: 0 wt.-%) and as salt tetrasodium pyrophosphate is used.

TABLE 1
Composition of the butadiene rubber latex S-A1

| Latex | S-A1-1 |
|---|---|
| Monomer butadiene/styrene | 90/10 |
| Seed Latex (wt.-% based on monomers) | ./. |
| Emulsifier (wt.-% based on monomers) | 2.80 |
| Potassium Persulfate (wt.-% based on monomers) | 0.10 |
| Decomposed Potassium Persulfate (parts per | 0.068 |
| 100 parts latex solids) | |
| Salt (wt.-% based on monomers) | 0.559 |
| Salt amount relative to the weight of solids of the | 0.598 |
| rubber latex | |
| Monomer conversion (%) | 89.3 |
| Dw (nm) | 87 |
| pH | 10.6 |
| Latex solids content (wt-%) | 42.6 |
| K | 0.91 |

K = W * (1-1.4 * S ) * Dw
W = decomposed potassium persulfate [parts per 100 parts rubber]
S = salt amount in percent relative to the weight of solids of the rubber latex
Dw = weight average particle size (=median particle diameter D₅₀) of the fine-particle butadiene rubber latex (S-A1)

### Production of the Coarse-Article, Agglomerated Butadiene Rubber Latices (A1)

The production of the coarse-particle, agglomerated butadiene rubber latices (A1) was performed with the specified amounts mentioned in table 2. The fine-particle butadiene rubber latex (S-A1) was provided first at 25° C. and was adjusted if necessary with deionized water to a certain concentration and stirred. To this dispersion an amount of acetic anhydride based on 100 parts of the solids from the fine-particle butadiene rubber latex (S-A1) as fresh produced aqueous mixture with a concentration of 4.58 wt.-% was added and the total mixture was stirred for 60 seconds.

After this the agglomeration was carried out for 30 minutes without stirring. Subsequently KOH was added as a 3 to 5 wt.-% aqueous solution to the agglomerated latex and mixed by stirring. After filtration through a 50 μm filter the amount of coagulate as solid mass based on 100 parts solids of the fine-particle butadiene rubber latex (B) was determined. The solid content of the agglomerated butadiene rubber latex (A), the pH value and the median weight particle diameter D₅₀ was determined.

TABLE 2
Production of the coarse-particle, agglomerated
butadiene rubber latices (A1)

| | | latex A1 | |
|---|---|---|---|
| | | A1-1 | A1-2 |
| | | used latex S-A1 | |
| | | S-A1-1 | S-A1-1 |
| concentration latex S-A1 before | wt.-% | 37.4 | 37.4 |
| agglomeration | | | |
| amount acetic anhydride | parts | 0.90 | 0.91 |
| amount KOH | parts | 0.81 | 0.82 |
| concentration KOH solution | wt-% | 3 | 3 |
| solid content latex A1 | wt-% | 32.5 | 32.5 |
| coagulate | parts | 0.01 | 0.00 |
| PH | | 9.0 | 9.0 |
| D₅₀ | nm | 315 | 328 |

### Production of Graft Copolymer (A)

59.5 wt.-parts of mixtures of the coarse-particle, agglomerated butadiene rubber latices A1-1 and A1-2 (ratio 50:50, calculated as solids of the rubber latices (A1)) were diluted with water to a solid content of 27.5 wt.-% and heated to 55° C. 40.5 wt.-parts of a mixture consisting of 72 wt.-parts styrene, 28 wt.-parts acrylonitrile and 0.4 wt.-parts tert-dodecylmercaptan were added in 3 hours 30 minutes. At the same time when the monomer feed started the polymerization was started by feeding 0.15 wt.-parts cumene hydroperoxide together with 0.57 wt.-parts of a potassium salt of disproportionated rosin (amount of potassium dehydroabietate: 52 wt.-%, potassium abietate: 0 wt.-%) as aqueous solution and separately an aqueous solution of 0.22 wt.-parts of glucose, 0.36 wt.-% of tetrasodium pyrophosphate and 0.005 wt.-% of iron-(II)-sulfate within 3 hours 30 minutes. The temperature was increased from 55 to 75° C. within 3 hours 30 minutes after start feeding the monomers. The polymerization was carried out for further 2 hours at 75° C. and then the graft rubber latex (=graft copolymer A) was cooled to ambient temperature. The graft rubber latex was stabilized with ca. 0.6 wt.-parts of a phenolic antioxidant and precipitated with sulfuric acid, washed with water and the wet graft powder was dried at 70° C. (residual humidity less than 0.5 wt.-%).

### Component (B)

Statistical copolymer (B-1) from styrene and acrylonitrile with a ratio of polymerized styrene to acrylonitrile of 72:28 with a weight average molecular weight Mw of 110,000 g/mol, and a MFI at 220° C./10kg of 61 g/10 minutes, produced by free radical solution polymerization.

Statistical copolymer (B-2) from styrene and acrylonitrile with a ratio of polymerized styrene to acrylonitrile of 78:22 with a weight average molecular weight Mw of 165,000 g/mol, and a MFI at 220° C./10kg of 36 g/10 minutes, produced by free radical solution polymerization.

### Component (C)

Fine-Blend® SAM-010 (terpolymer of styrene, acrylonitrile and maleic anhydride, with 8±2 wt.-% maleic anhydride, Mw 90,000 to 100,000 g/mol) from Fine-blend Compatilizer Jiangsu Co., LTD, China.

### Component (D)

Hollow glass beads having a true density of 0.58 to 0.62 g/cm³, a bulk density of 0.33 to 0.36 g/cm³ and a compressive strength of 125 MPa, particle diameter (D50) 35 μm.

| | |
|---|---|
| Material Name | Hollow glass microspheres HK60 - 18000 |
| Chemical Name | Soda Lime Borosilicate Glass CAS |
| | No.(65997-17-3) |
| Trade Name | HK60- 18000 |
| Supplier | Zhengzhou Hollowlite Materials Co., Ltd |

### Component (E)

Chopped glass fibers—composed of Aluminium borosilicate (E-glass) with less than 1% alkali oxides—having a diameter and length of 13 μm and 3 mm, respectively and a density of 2.6 g/cm³. The surface of the glass fibers is given a Silane treatment. Said glass fibers are commercially available from Nippon Electric glass, Japan.

### Component (F)

| | |
|---|---|
| F1 | Ethylene bis stearamide (EBS) ‘Palmowax’ from |
| | Palmamide Sdn Bhd, Malaysia |
| F3 | Magnesium oxide (MgO) from Kyowa Chemicals |
| F4 | Distearyl pentaeritritol diphosphite (SPEP) from |
| | Addivant, Switzerland |
| F5 | Silicon oil having a kinematic viscosity of 1000 |
| | centiStokes from KK Chempro India Pvt Ltd |

### Thermoplastic Compositions

All components were weighed and used in amounts according to the compositions given in Tables 3 and 4.

The batch size for all the compounding and extrusion trials was 10 kg. Components (A), (B), (C) and (F) were mixed for 2 to 3 minutes at an average speed of 2200 rpm in a high speed mixer to obtain a uniform premix and then the hollow glass beads (HGB, component (D))—mixed with 1% water—were added to the premix and then mixed for only 20-30 seconds at 2200 rpm to attain good dispersion and create uniform premix for compounding. Minimum time is kept for mixing after adding HGB to avoid the undesired breakage of the HGB. The premix prepared was then extruded through a twin-screw extruder. The extruder has co-rotating screws and has a separating feeding hopper (side feeder) after mixing zones, for feeding glass fibres (component (E)). The premix was melt blended in said twin-screw extruder at a screw speed of 350 rpm and using an incremental temperature profile from 215° C. to 250° C. for the different barrel zones. The glass fibres were separately fed during compounding through said side feeder of the extruder. The extruded reinforced polymer blend strands were water cooled, air-dried and pelletized.

This was followed by injection moulding to mould the standard test specimens. The temperature profile of the injection moulding machine barrel was 220 to 240° C. incremental. The test data of the obtained ABS compositions are shown on Table 5 and 6.

TABLE 3
Reinforced ABS compositions
Compound set 1 (amounts in wt.-%)

| | Comparative | Comparative | Comparative | Comparative |
|---|---|---|---|---|
| Components | Example 1 | Example 2 | Example 3 | Example 4 |
| A | 19.57 | 19.57 | 19.57 | 19.57 |
| B1 | 63.60 | 53.82 | | 78.28 |
| B2 | | | 68.49 | |
| C | 4.89 | 4.89 | | |
| D | 9.78 | 19.57 | | |
| E | | | 9.78 | |
| F 1 | 1.47 | 1.47 | 1.47 | 1.47 |
| F 2 | 0.29 | 0.29 | 0.29 | 0.29 |
| F 3 | 0.10 | 0.10 | 0.10 | 0.10 |
| F 4 | 0.15 | 0.15 | 0.15 | 0.15 |
| F 5 | 0.15 | 0.15 | 0.15 | 0.15 |

TABLE 4
Reinforced ABS compositions

| | Compound set 2 (amounts in wt.-%) | | | |
|---|---|---|---|---|
| | | | Comparative | Comparative |
| Components | Example 1 | Example 2 | Example 3 | Example 5 |
| A | 19.57 | 19.57 | 19.57 | 19.57 |
| B1 | 53.82 | 44.03 | | 58.71 |
| B2 | | | 68.49 | |
| C | 4.89 | 4.89 | | |
| D | 9.78 | 19.57 | | |
| E | 9.78 | 9.78 | 9.78 | 19.57 |
| F 1 | 1.47 | 1.47 | 1.47 | 1.47 |
| F 2 | 0.29 | 0.29 | 0.29 | 0.29 |
| F 3 | 0.10 | 0.10 | 0.10 | 0.10 |
| F 4 | 0.15 | 0.15 | 0.15 | 0.15 |
| F 5 | 0.15 | 0.15 | 0.15 | 0.15 |

TABLE 5
Properties - Compound set 1

| | | Compound set 1 | | | |
|---|---|---|---|---|---|
| | | Comparative | Comparative | Comparative | Comparative |
| Properties | Unit | Example 1 | Example 2 | Example 3 | Example 4 |
| Melt Flow Rate | g/10 min | 21.5 | 14 | 9 | 47.5 |
| NIIS, 6.4 mm | kg · cm/cm | 2.1 | 1.8 | 5.0 | 8.0 |
| Tensile Strength | kg/cm² | 410 | 365 | 575 | 495 |
| Tensile Modulus | kg/cm² | 32950 | 34600 | 45000 | 29200 |
| Elongation at Break | % | 5 | 3 | 4 | 17 |
| Flexural Strength | kg/cm² | 860 | 780 | 900 | 935 |
| Flexural Modulus | kg/cm² | 35200 | 36350 | 34000 | 32550 |
| Rockwell Hardness | R-Scale | | | 110 | |
| HDT, Annealed | ° C. | 97.5 | 97 | 99 | 98.0 |
| VST | ° C. | 100 | 101.5 | 105 | 100.5 |
| Specific gravity | — | 1.015 | ~0.9 | 1.1 | 1.055 |
| Strength to weight | — | 403.9 | 405.6 | 522.7 | 469.2 |
| ratio | | | | | |
| Yellowness Index | — | 23.03 | 17.15 | | 28.69 |

TABLE 6
Properties - Compound set 2

| | | | | Comparative | Comparative |
|---|---|---|---|---|---|
| Properties | Unit | Example 1 | Example 2 | Example 3 | Example 5 |
| Melt Flow Rate | g/10 min | 13.0 | 6.0 | 9 | 20.5 |
| NIIS, 6.4 mm | kg · cm/cm | 6.0 | 4.5 | 5.0 | 5.5 |
| Tensile Strength | kg/cm² | 650 | 550 | 575 | 810 |
| Tensile Modulus | kg/cm² | 58400 | 55900 | 45000 | 67550 |
| Elongation at Break | % | 2.4 | 1.9 | 4 | 1.7 |
| Flexural Strength | kg/cm² | 1205 | 1030 | 900 | 1260 |
| Flexural Modulus | kg/cm² | 54650 | 52800 | 34000 | 66950 |
| Rockwell Hardness | R-Scale | 108 | 107 | 110 | 111 |
| HDT, Annealed | °C | 101 | 99.5 | 99 | 101 |
| VST | °C | 106 | 105 | 105 | 103.5 |
| Specific gravity | — | 1.094 | 1.023 | 1.1 | 1.198 |
| Strength to weight ratio | — | 594 | 537.6 | 522.7 | 676.1 |
| Yellowness Index | — | 22.71 | 19.38 | | 32.38 |

The data according to Table 6 prove that the inventive reinforced ABS compositions (Examples 1 and 2) have a reduced specific gravity without compromising the mechanical properties in comparison to non-inventive or prior art reinforced ABS compositions.

Even with a load of only 9.78 wt.-% glass fiber good mechanical properties—close to mechanical properties obtained for 19.57 wt.-% glass fiber filled ABS compositions (cp. comparative Example 5)—are achieved with a lower specific gravity.

Thus, the reinforced ABS compositions according to the invention combine lightweight and good mechanical properties with a better cost efficiency (in comparison to expensive fibers like carbon/nanotube).

1-15. (canceled)

16. A thermoplastic molding composition comprising components A, B, C, D, E, and, if present, F:
(A) 5.0 to 57.0 wt.-% of at least one graft copolymer (A) consisting of 15 to 60 wt.-% of a graft sheath (A2) and 40 to 85 wt.-% of a graft substrate (A1), wherein the graft substrate (A1) is an agglomerated butadiene rubber latex and wherein (A1) and (A2) sum up to 100 wt.-%,
obtained by emulsion polymerization of
styrene and acrylonitrile in a weight ratio of 95:5 to 50:50 to obtain the graft sheath (A2), wherein the styrene and/or the acrylonitrile is optionally partially replaced by alpha-methylstyrene, methyl methacrylate, maleic anhydride, or mixtures thereof,
in the presence of at least one agglomerated butadiene rubber latex (A1) with a median weight particle diameter D50 of 200 to 800 nm;
wherein the agglomerated butadiene rubber latex (A1) is obtained by agglomeration of at least one starting butadiene rubber latex (S-A1) having a median weight particle diameter D₅₀ of equal to or less than 120 nm;
(B) 30.5 to 80 wt.-% of at least one copolymer (B) of styrene and acrylonitrile in a weight ratio of from 81:19 to 65:35, wherein the styrene and/or the acrylonitrile is optionally partially replaced by methyl methacrylate, alpha-methyl styrene, and/or 4-phenylstyrene;
wherein copolymer (B) has a weight average molar mass M_{w} of 90,000 to 145,000 g/mol;
(C) 1.5 to 9.5 wt.-% of at least one copolymer (C) with at least one functional group selected from epoxy, maleic anhydride, and maleic imide as a compatibilizing agent;
(D) 5 to 29 wt.-% of hollow glass microspheres (D);
(E) 6 to 12 wt.-% of glass fibers (E); and
(F) 0 to 5 wt.-% of at least one additive and/or processing aid (F) which is different from (D) and (E);
wherein the components A, B, C, D, E, and, if present F, sum to 100 wt.-%.

17. The thermoplastic molding composition of claim 16 comprising components A, B, C, D, E, and F in the following amounts:
(A): 5.99 to 50.99 wt.-%;
(B): 35 to 80 wt.-%;
(C): 2 to 8 wt.-%;
(D): 5 to 25 wt.-%;
(E): 7 to 11.5 wt.-%; and
(F): 0.01 to 5 wt.-%.

18. The thermoplastic molding composition of claim 16 comprising components A, B, C, D, E, and F in the following amounts:
(A): 11.95 to 41.95 wt.-%;
(B): 40 to 70 wt.-%;
(C): 3 to 6 wt.-%;
(D): 8 to 22 wt.-%;
(E): 7 to 11.5 wt.-%; and
(F): 0.05 to 4 wt.-%.

19. The thermoplastic molding composition of claim 16, wherein component (C) comprises structural units derived from maleic imide and/or maleic anhydride in an amount of from 6 to 12 wt.-%.

20. The thermoplastic molding composition of claim 16, wherein component (C) is selected from the group consisting of: styrene-maleic anhydride copolymers, styrene-acrylonitrile-maleic anhydride-terpolymers, styrene-N-phenyl maleic imide-copolymers, and styrene-acrylonitrile-N-phenyl maleic imide-terpolymers.

21. The thermoplastic molding composition of claim 16, wherein the hollow glass microspheres (D) have a particle size (D₅₀) in the range of 25 to 45 μm.

22. The thermoplastic molding composition of claim 16, wherein the glass fibers (E) are chopped glass fibers.

23. The thermoplastic molding composition of claim 16, wherein the agglomerated butadiene rubber latex (A1) has a median weight particle diameter D₅₀ of 280 to 350 nm.

24. The thermoplastic molding composition of claim 16, wherein the graft sheath (A2) is obtained by emulsion polymerization of styrene and acrylonitrile solely; and copolymer (B) is a copolymer of styrene and acrylonitrile solely.

25. The thermoplastic molding composition of o claim 16, wherein copolymer (B) is a copolymer of styrene and acrylonitrile in a weight ratio of from 76:24 to 70:30.

26. The thermoplastic molding composition of claim 16, wherein copolymer (B) has a melt flow index (MFI) of more than 60 g/10 min (ASTM D1238).

27. A process for the preparation of the thermoplastic molding composition of claim 16 comprising the following steps:
i) optionally premixing of components A, B, C, D, and, if present, F,
ii) melt mixing and kneading or rolling of components A, B, C, D, and, if present, F, or of the mixture obtained in step i), to obtain a molten uniform mixture at a temperature in the range of from 160° C. to 300° C., and
iii) addition of component E) in the molten uniform mixture obtained in step ii).

28. A shaped article comprising the thermoplastic molding composition of claim 16.

29. An electronic application comprising the thermoplastic molding composition of claim 16.

30. An electronic application comprising the shaped article of claim 28.

31. An electronic device requiring a high endurance and fatigue resistance comprising the thermoplastic molding composition of claim 16.

32. An electronic device requiring a high endurance and fatigue resistance comprising the shaped article of claim 28.

33. The thermoplastic molding composition of claim 16, wherein:
(A) the at least one graft copolymer (A) consists of 20 to 50 wt.-% of the graft sheath (A2) and 50 to 80 wt.-% of the graft substrate (A1),
wherein the agglomerated butadiene rubber latex (A1) is obtained by agglomeration of at least one starting butadiene rubber latex (S-A1) having a median weight particle diameter D₅₀ of equal to or less than 110 nm.

34. The thermoplastic molding composition of claim 16, wherein the hollow glass microspheres (D) have a particle size (D₅₀) in the range of 30 to 40 μm.

35. The thermoplastic molding composition of claim 16, wherein the agglomerated butadiene rubber latex (A1) has a median weight particle diameter D₅₀ of 300 to 350 nm.
